(19) United States
(12) Patent Application Publication
(10) Pub. No.: US 2025/0363561 A1
(43) Pub. Date: Nov. 27, 2025

(54) METHOD OF INVESTMENT EVALUATION USING ESTIMATED VALUE BASED ON REFERENCE VALUE

(71) Applicants: Hyunjin KWON, Daejeon (KR); Bongki MHEEN, Daejeon (KR); MK Associates Inc., Daejeon (KR)

(72) Inventors: Kyoungwhan MHEEN, Daejeon (KR); Hyunjin KWON, Daejeon (KR); Bongki MHEEN, Daejeon (KR)

(73) Assignees: Hyunjin KWON, Daejeon (KR); Bongki MHEEN, Daejeon (KR); MK Associates Inc., Daejeon (KR)

(21) Appl. No.: 19/061,716

(22) Filed: Feb. 24, 2025

(30) Foreign Application Priority Data
May 22, 2024 (KR) 10-2024-0066288

(51) Int. Cl. G06Q 40/06

(52) U.S. Cl. CPC G06Q 40/06

(57) ABSTRACT

Proposed is a method of investment evaluation using an estimated value based on a reference value. The method includes, via computer execution, determining a reference value from either historical values or future reference values of an underlying asset value—the underlying asset value being the price of an underlying asset chosen as a representative investment asset or a related benchmark index from an investment asset set-in accordance with a predetermined rule, and converting the investment asset set's valuation into an estimated value based on a reference value by applying a variability ratio, calculated under the assumption that the underlying asset value at the evaluation time is adjusted to match the determined reference value.

### CROSS REFERENCE TO RELATED APPLICATION

The present application claims priority to Korean Patent Application No. 10-2024-0066288, filed May 22, 2024, the entire contents of which is incorporated herein for all purposes by this reference.

### BACKGROUND

### Technical Field

The present disclosure relates to a method of investment evaluation using an estimated value based on a reference value, which is designed to help an investor with various investments such as financial products and real estate, as well as judgment and investment decisions related to such investments.

### Description of the Related Art

Humans have been investing surplus cash and other tangible and intangible assets (labor, real estate, etc.) in assets in various fields for a very long time. The purpose is to establish a more advantageous economic position in the future, and some investor groups have, in fact, achieved great success and generated exceptionally high returns.

In modern times, due to the decline in the value of currency and the development of advanced technology and the financial industry, it is becoming increasingly difficult to maintain long-term financial stability by creating economic value solely by relying on absolute labor time, and collecting value through traditional methods of financial investment such as bank deposits. For this reason, investment is becoming a very important consideration for the public as well.

In response to the changes in the overall economic situation, the public is investing in various ways but in most cases, investments are not successful from the perspective of the general public without specialized knowledge. The reasons for the failure of public investments, which are, in some ways, more important from a social perspective, can be divided into psychological factors, behavioral factors, and environmental factors.

The tendencies of psychological factors include 1) Emotional Decision Making, where emotions interfere with rational judgment and cause suboptimal decisions influenced by fear or excessive risk-seeking behavior, 2) Confirmation Bias, which is the tendency for people to selectively accept only information that supports their existing beliefs or theories and ignore information that contradicts them, 3) Overconfidence, which is the tendency to underestimate risks and take excessive risks by having excessive confidence in one's own judgment or information, 4) Loss Aversion, which involves unnecessarily taking on additional risks to avoid losses or, conversely, realizing profits too early to minimize Groupthink, which is the inability to make losses, 5) independent judgments due to influence by popular opinions within a specific social group or investment community, 6) Anchoring, which refers to the tendency to rely too heavily on information or prices initially presented and to anchor subsequent judgments in that information, 7) Hindsight Bias, which is the phenomenon of mistakenly believing that an event was predictable after the event occurred, which leads to overestimation of past judgments, and 8) Mental Accounting, which is the tendency to divide money into several “accounts” with different values, which leads to inefficient investment decisions.

The tendencies of behavioral factors include 1) Information Accessibility, which is a factor that focuses on individual behavior and judgment, and the quantity and quality of information accessible to an individual investor influences behavior and decisions, 2) Social Influence, where the opinions and actions of people around an individual influence an individual's investment decisions, and 3) Technological Factors, in which technological advancement changes the way investors behave.

The tendencies of environmental factors include 1) Market Trends and Media Influence, which shape the investment environment and influence investor decisions, 2) Economic Environment, where interest rates, inflation, economic growth rate, etc. are important external factors in investment decisions, and 3) Policy and Regulatory Environment, which affects the structure and operation method of the investment market.

Because many of the above complex factors are closely interconnected, effective analysis is difficult when making investments. Moreover, because they are not psychologically trained, most individual, retail investors are prone to failure in investing, which is why it is difficult for the general public to invest wisely. As a result, individuals who have failed or are having difficulty investing mainly rely on preset bank interest rates, commonly referred to as deposits, to make investments. However, relying solely on a single, limited investment method such as bank deposits is likely to result in suboptimal investment performance, especially in a highly competitive and technologically advanced investment environment where more diversified investment strategies are employed. Therefore, when looking at an individual's entire life, it is essential to make successful and stable investments in areas other than deposits in advance in order to stably survive retirement, a period in which the value of labor power decreases as one ages.

In conclusion, from the perspective of the public who absolutely needs to invest, it is very important successful investment to reduce as much as possible for the negative factors from psychological, behavioral and environmental perspectives that are causing the numerous problems mentioned above by providing a general basis for judgment that is helpful in evaluating investment activities and investment results.

### SUMMARY

Accordingly, the present disclosure has been made keeping in mind the above problems occurring in the related art, and the present disclosure is intended to provide a more intuitive way to judge investment performance even though there are various factors that hinder investment when making an investment, thereby reducing or allowing to overcome one or more of the psychological, behavioral, and environmental factors that are problematic during investment.

In addition, from the perspective of financial institutions such as securities companies and investment advisors, an objective of the present disclosure is to enable the financial institutions to attract more investors by allowing individual investors to more clearly compare the performance of their financial products.

An objective of the present disclosure is to provide a means that allows users or investors to easily know whether additional profits are generated from the current investment regardless of market conditions such as a decline in the price of an underlying asset, and to immediately know whether the amount of profit increases or decreases if profit is generated, or whether the rate of increase or decrease of profit is constant or irregular over time. This, in turn, provides a means to facilitate comparison of investment performance between existing investment products, and a means to easily and immediately compare how superior or inferior current investment performance is compared to past investment performance, even within the same investment product.

In order to achieve the above objective, according to an aspect of the present disclosure, there is provided a method of investment evaluation using an estimated value based on a reference value. The method is executed by a computer and includes: determining, according to a predetermined rule, a reference value selected from either historical values or future reference values of an underlying asset value, the underlying asset value corresponding to a price of an underlying asset chosen as a representative investment asset or a related benchmark index from one or more investment assets included in an investment asset set; and converting, based on a variability ratio calculated under the assumption that the underlying asset value at an evaluation time changes to the determined reference value, a valuation of the investment asset set, and using the resulting converted valuation as an estimated value based on a reference value.

In the method of investment evaluation using an estimated value based on a reference value, the predetermined rule may include selecting, as the reference value, the highest price recorded among the historical values of the underlying asset value from the start of an investment up to just before the evaluation time.

In the method of investment evaluation using an estimated value based on a reference value, when the underlying asset value is at the highest price at the evaluation time, an evaluated value of assets held, which is a valuation of the one or more investment assets included in the investment asset set at the time of evaluation, may equal to the estimated value based on a reference value.

In the method of investment evaluation using an estimated value based on a reference value, the investment asset set may be an investment product whose composition of asset types and quantities may vary over time, and may be used to evaluate an investment performance of the investment product.

The method of investment evaluation using an estimated value based on a reference value may further include calculating and utilizing one or more metrics of the estimated value based on a reference value, the metrics including at least one of a growth rate, a slope, or a derivative value.

The method of investment evaluation using an estimated value based on a reference value may further include displaying, in graph form, a historical record of the estimated value based on a reference value up to the evaluation time, or a historical record of change rates of the estimated value based on a reference value.

In the method of investment evaluation using an estimated value based on a reference value, if the investment asset set includes Bitcoin, the underlying asset may be Bitcoin.

In the method of investment evaluation using an estimated value based on a reference value, the variability ratio may be a unique value predicting a rate of change in a value of each investment asset when the underlying asset value reaches the determined reference value, and may be derived via time series analysis based on historical price change data of the underlying asset and each investment asset.

According a method of investment evaluation using an estimated value based on a reference value of the present disclosure, investors can see more clearly how well their current investment performance is maintained by checking data on an “estimated value based on a reference value” for an investment product or investment position and various characteristics derived from the data, such as trend or slope graphs, etc.

In particular, even with a conventional and universal method, one can tell whether their current investment is progressing well by comparing an asset price (“underlying asset value” or benchmark index) that is the basis for investment and the investment valuation of the currently held assets (“evaluated value of assets held”). For example, one can simply compare and evaluate two figures at a specific point in time, for example a month ago and now, by comparing an “underlying asset value” and the current “evaluated value of assets held” for each of the two points in time. On the other hand, the “estimated value based on a reference value” proposed in the present disclosure allows accurate comparison of whether the investment is progressing well at all points in time with this figure (“estimated value based on a reference value”) alone, and makes it easy to judge investment performance because the figure can clearly present investment performance resulting from investment activities, including buying and selling, that occurred over time even within the same investment product.

Furthermore, the “estimated value based on a reference value” of the present disclosure can provide investors with a sense of stability. This is because even in situations where the current investment valuation is lower than that of the time of investment or has fallen from the previous high valuation, an “estimated value based on a reference value” with a certain standard regardless of changes in a “reference value” can be obtained. Particularly, investment performance resulting from investment activities, including buying and selling, can be checked in real time through an increase in this “estimated value based on a reference value” or an increasing slope in a graph. The “estimated value based on a reference value” of the present disclosure can reduce misinterpretations in an “evaluated value of assets held” due to changes in an asset price (benchmark index) that is the basis for investment, that is, the “underlying asset value”, and readily indicate whether there is an improvement in investment performance resulting from investment activities even in a declining (or bearish) market, thereby significantly reducing or eliminating problems caused by various psychological, behavioral, and environmental factors, ultimately even enabling individuals without professional training in investment to make stable investments over a long period of time.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is an example view showing the performance of an existing financial product;

FIG. 2 is an example of a graph showing the price of one Bitcoin, an underlying asset, over time as an example for explaining an “underlying asset value”;

FIG. 3 is an example of a graph showing the change over time in the valuation of invested assets, including Bitcoin, an underlying asset, as an example for explaining an “evaluated value of assets held”;

FIG. 4 is an example of a graph showing the change in a “reference value” over time when the “reference value” is set as the highest point among reference values after investment as an example for explaining a “reference value”;

FIG. 5 is an example showing an “estimated value based on a reference value” together with an “evaluated value of assets held” as an example that can be implemented according to the present disclosure; and

FIG. 6 shows as an example the relative change rate for each of the “underlying asset value”, the “evaluated value of assets held”, the “reference value”, and the “estimated value based on a reference value” from FIGS. 2 to 5, and is an example graph showing the rate of change since the first investment as a percentage.

### DETAILED DESCRIPTION

Hereinafter, with reference to the attached drawings, embodiments of the present disclosure will be described in detail so that those skilled in the art can easily practice the present disclosure. However, the present disclosure may be implemented in many different forms and is not limited to the embodiments described herein. In addition, in order to facilitate understanding of the present disclosure in the drawings, parts that are not related to the description are omitted, and similar parts are given similar reference numerals throughout the specification.

In the specification, when a part is said to “comprise (include)” a certain component, unless specifically stated to the contrary, this does not mean excluding other components, but rather including the other components.

Expressions described as singular in this specification may be interpreted as singular or plural, unless explicit expressions such as “one” or “single” are used.

Terms containing ordinal numbers, such as first, second, etc., used in embodiments of the present disclosure may be used to describe components of the present disclosure, but the components should not be limited by the terms. The terms are used solely for the purpose of distinguishing one component from another. For example, a first component may be referred to as a second component, and similarly, the second component may be referred to as the first component without departing from the scope of the present disclosure.

Hereinafter, a method of investment evaluation using an estimated value based on a reference value according to an embodiment of the present disclosure will be described with reference to the drawings, the method of investment evaluation of the present disclosure may be executed on various types of computers such as PCs, tablets, smartphones, servers, and workstations, and if necessary, information generated by these computers can be transmitted to a remote computer, and information connected directly or transmitted remotely can be displayed on a monitor device.

In the present disclosure, an “underlying asset value” is the price of an underlying asset for assets held, and is chosen as a representative investment asset or related benchmark index from one or more investment assets included in an investment asset set.

An “underlying asset value” may be the valuation of an asset that is the basis for investment. Assuming that there is an investment asset invested in the stocks of several listed companies based on KOSPI200, in this case, an underlying asset value may be the “KODEX 200” product (code name: 069500) representing KOPSI200. In the case of an invested crypto asset, including Bitcoin and multiple altcoins, an underlying asset value may be set at the BTCUSD price equivalent to the price of one Bitcoin on the Binance exchange with the largest trading volume. It will be appreciated that an underlying asset value may be another similar product other than the “KODEX 200” product (code name: 069500) representing KOPSI200, and in addition to the BTCUSD price on the Binance Exchange, which corresponds to the price of one Bitcoin, the Korean Won per Bitcoin traded on the Korea Upbit Exchange may also be an underlying asset value. It is important to note that an “underlying asset value” is used to present a benchmark index that serves as a standard for comparative evaluation of invested assets. This is a generally accepted concept, and an “underlying asset value” is often used for comparison when showing investment performance.

An “evaluated value of assets held” referred to in the present disclosure generally refers to the total valuation of the investment assets or the valuation of each investment asset within the investment when making an investment. Thus, an “evaluated value of assets held” may be the valuation of the entire investment asset(s) included in an investment product. Usually, an “evaluated value of assets held” changes at every moment according to changes in the value of the field in which the investment is being made, and an “evaluated value of assets held” may also change due to changes in an “underlying asset value” described above. However, changes in an “evaluated value of assets held” do not exactly correspond to changes in an “underlying asset value” because variability ratios of the actual assets held and an “underlying asset value” do not exactly match. In essence, as an “underlying asset value” rises and falls, an “evaluated value of assets held” also rises and falls, and the investment may be considered to exhibit better performance in the relevant investment field only when the increase/decrease in an “evaluated value of assets held” is greater in the positive direction than the increase/decrease in the same “underlying asset value”. This also means that although an “underlying asset value” and an “evaluated value of assets held” generally move in a similar direction due to the characteristics of “underlying an asset value”, the increase/decrease ratio of an “underlying asset value” may not be the ratio of an “evaluated value of assets held”. To summarize, although changes in an “evaluated value of assets held” are influenced by changes in an “underlying asset value”, as investment time passes, the investment performance of the investment assets can be said to be superior to the underlying assets only when an “evaluated value of assets held” is higher than the result of the increase or decrease in an “underlying asset value”.

Next, a “reference value” in the present disclosure is a concept related to an “underlying asset value” on which investment is made, and serves as a standard for calculating an “estimated value based on a reference value”, which will be explained later, by setting a “reference value” according to a specific standard. A “reference value” may be determined, based on a predetermined rule, from either historical values or expected future values of an “underlying asset value”. For example, a “reference value” may be set as an “underlying asset value” at the time the investment begins, or as the highest “underlying asset value” after investment begins. In this case, the “reference value” is determined by the highest “reference value” price among the historical values of the “underlying asset value” from the start of investment to the time of evaluation.

As another way of determining a “reference value”, a “reference value” may be set as a future reference value by using an “underlying asset value” that may occur in the future rather than the past historical value of an “underlying asset value”. The important point in determining a “reference value” is to set a “reference value” according to a predetermined rule, which becomes a standard for calculating an “estimated value based on a reference value”, which will be explained next. Therefore, there is no problem with the way of determining a “reference value”, no matter what value it is, as long as it can serve as a standard for setting an “estimated value based on a reference value”.

While there is no problem in setting a “reference value” in various ways, it should be noted in advance that a “reference value” may be set in a specific way from the perspective of the utility of an “estimated value based on a reference value”, which will be explained further later.

Lastly, an “estimated value based on a reference value” will be described. An “estimated value based on a reference value” may be the amount equivalent to an estimated “evaluated value of assets held” when the current “underlying asset value” is changed (reached) to a “reference value”. The valuation of one or more investment assets included in the investment asset set at the time of evaluation may be converted on the basis of a variability ratio when an “underlying asset value” is assumed to change to a “reference value” determined as above, and determined as an “estimated value based on a reference value”. The variability ratio is a unique value predicting the rate of change in the value of each investment asset when the underlying asset value reaches the reference value determined above, and is determined through time series analysis based on historical price change data of an underlying asset and each investment asset.

The greatest value of the “estimated value based on a reference value”, which is the core of the present disclosure is that it has the advantage of being able to very easily check the performance of the current investment in real time in a way that reduces the influence of changes in an “underlying asset value” by calculating an “estimated value based on a reference value” on the basis of a “reference value”, which is the price determined by a predetermined rule instead of calculating an “estimated value based on a reference value” on the basis of the currently changed “underlying asset value”.

As a more specific example, in order to explain an “estimated value based on a reference value” above, an example will be given of the result data of a financial product that made related investments, including Bitcoin, which has very high volatility. Although an investment asset set consists of various investment elements, if the investment asset set includes Bitcoin and Bitcoin has the greatest influence, an underlying asset may be set as the price of one Bitcoin. If one invests in an investment asset containing Bitcoin as mentioned above, the invested amount will fluctuate to some extent in proportion to the price of one Bitcoin, that is, the “underlying asset value”, depending on the percentage of Bitcoin included. As previously described, since this investment product may also include cash or other similar assets or investment positions in addition to Bitcoin, it is obvious that the invested amount is not completely consistent with the fluctuations in the price of Bitcoin. In this case, an “evaluated value of assets held” changes similar to the change in the Bitcoin price, but will fluctuate differently, and thus it is challenging to quantitatively assess the investment product's relative performance against fluctuations in the Bitcoin price. That is, it is difficult to measure accurate investment performance because both the Bitcoin price and an “evaluated value of assets held”, which is the amount currently evaluated by investment, continue to change after initial investment. When Bitcoin rises, what is important is how much one's holdings have risen compared to the rise rate of Bitcoin, and when Bitcoin falls, one needs to judge how much the valuation of one's holdings has fallen, but because both the Bitcoin price and the valuation of one's holdings are constantly changing, direct comparison is difficult. Now, as an embodiment of the present disclosure, it is assumed that a “reference value” is set at the maximum price per bitcoin after investing in the above-mentioned financial product. Under this condition, the figure of an “estimated value based on a reference value”, converted based on a “reference value”, which is the same condition, may almost eliminate the price fluctuations of Bitcoin, an “underlying asset value”, which changes every time. Thus, one can clearly see whether he or her is making a profit or a loss with that investment at every moment or time period, regardless of the rise or fall of the reference asset, i.e. Bitcoin.

This concept may be explained again using an investment process as an example. Generally, most investments are completed by purchasing a specific investment asset for cash or performing an equivalent action across a variety of investment assets. When the investment is completed in this way, the investment valuation (i.e., an “evaluated value of assets held” described above), which is the valuation of the assets held, changes from time to time according to changes in the valuation of a reference unit of the investment assets (i.e., an “underlying asset value” described above).

Depending on the investment situation, an “underlying asset value” may continuously increase and reach the highest amount, and at this time, an “evaluated value of assets held” may surpass all past “evaluated value of assets held” records and become the highest “evaluated value of assets held”. Such situation is generally referred to as an all-time-high (hereinafter ATH situation). As an example, assuming that a reference value is the previous highest price of an underlying asset value since investment began, in an ATH situation, the reference value is updated with the underlying asset value. However, as is the case with most investments, in a situation where an underlying asset value falls below a reference value set as an example condition, the investment valuation also decreases at the same time compared to the previous investment valuation. Yet, even if the underlying asset value decreases, the reference value is maintained at the highest price under the predetermined conditions of the above example.

Generally, in the ATH state, that is, in the phase where an underlying asset value continues to simply rise beyond the previous high price, it is relatively easy to compare the increase in the valuation of underlying assets with the increase in the valuation of assets held, making it easy to evaluate current investments. When overall profits are being realized, investors may experience fewer market-driven stressors, potentially enabling more consistent decision-making aligned with their investment strategies.

On the other hand, in a phase where an underlying asset value is falling from the previous high point or in a phase where an underlying asset value is falling and rising repeatedly after falling from the previous high point, it is difficult to determine whether the current investment is performing well compared to the underlying asset value. One can get some idea by simply comparing the relative increase or decrease rates based on two specific reference points, but it is hard to tell whether the investment is progressing favorably at every moment in a situation where changes over time after the start of investment are accumulated.

Another important consideration is that, during such a downward phase, a significant decrease in the “evaluated value of assets held” relative to previous highs may increase perceived investment risk and uncertainty. In some cases, valuations below the initial principal may lead to a heightened focus on mitigating losses, making investors more responsive to negative market indicators.

Therefore, as can be seen from the above explanation, the important thing in investing is to be clearly aware of the fact that for all investment assets, there are times when asset status and the economy expand due to an economic upturn or a decrease in interest rates, and there are times when asset status and the economy contract, such as a decrease in asset valuation, due to an economic downturn or a rise in interest rates. If an easy and stable way could be provided to determine whether one's investment is doing well despite the fluctuations in the economic situation, it will be a very important factor in making investments more wisely during the entire investment period, which includes the expansion and contraction of the economy.

The present disclosure makes it much easier to understand the current investment status by presenting investors with an “estimated value based on a reference value” calculated on the basis of a “reference value” determined by a predetermined rule regardless of changes in an underlying asset value, and even in a situation where an “evaluated value of assets held” falls due to a decline in an “underlying asset value”, provides information on the increase in profits resulting from investment activities (all investment activities, including buying or selling, etc.) without the investment performance being affected by market conditions, thereby alleviating problems caused by investment sentiment and enabling stable investment throughout the entire investment period.

In ATH situations where the previous high is updated, there are many situations where an “evaluated value of assets held” is also updated to the highest, but such period of time is relatively short during the entire investment period. Rather, the important investment points which occupy a longer period of time during the entire investment period are when an “underlying asset value” and an “evaluated value of assets held” are lower than the previously achieved high points. In these times, it is very important for investors to effectively recognize the current investment situation evaluated by valuation, and the present disclosure makes this possible because although the asset valuation is lower than an evaluated value of assets held at the previous high point, one can directly and immediately check whether profits from investment are consistently generated even in such situation. Ultimately, this simultaneously alleviates the various problem factors that hinder humans from making investments as previously described, and helps to make better investments.

A more detailed explanation will be given with reference to the drawings as follows.

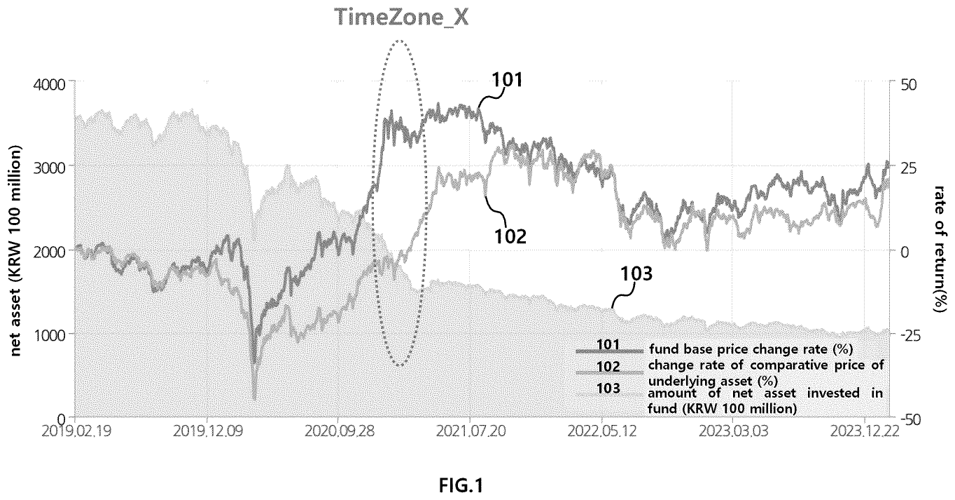

FIG. 1 is a graph related to the investment performance of a specific investment fund (more precisely, KB Active Dividend Securities Investment Trust (Stock) S Class) provided by a specific financial company (more precisely, FOSS Korea) during a specific period. The financial company explains the performance of the fund on a page called “How was the performance?” On the page, in the section titled “Profit Rate and Fund Size”, the performance from Feb. 19, 2019 to Dec. 22, 2023 is displayed as shown in FIG. 1. When explaining the contents of FIG. 1 in comparison with the present disclosure, the graph shows the rate of change (101) in an “evaluated value of assets held” when investing in the fund, shows the rate of change (102) in an “underlying asset value” based on an underlying asset that is the basis of assets invested in this fund, and shows another additional information, which is the rate of change (103) the amount invested in the fund relative to the total investment amount.

Assuming an investor started investing on Feb. 19, 2019 and continued until Dec. 22, 2023, what one can see from the graph is the rate of change in an “evaluated value of assets held” (about 25% in this graph example), and the rate of change in an “underlying asset value” (about 20% in this graph example), and accordingly, one can see that a 5-year investment is making a 5% profit compared to the investment in the underlying asset.

There are, however, many problems here. First, investors are able to evaluate the fund at two specific points in time (in the previous example, Feb. 19, 2019 and Feb. 19, 2024) while investing for five years starting on Feb. 19, 2019, but it is difficult to objectively evaluate the fund at any point in time, that is, the intermediate point in time. For example, as of Sep. 28, 2020, when the underlying asset value has fallen about-22%, the change rate of the evaluated value of assets held is 0%, and as of Jul. 20, 2021, when the underlying asset value was +22%, the evaluated value of assets held achieved approximately +31%, but because the underlying asset value has changed in both cases, it is relatively difficult to directly compare the investment performance of the two points.

As another problem, for an investor who started investing on Feb. 19, 2019, the above explanation would be possible, but since investors started investing at different times, it is more difficult to directly know the status of one's investment from the graph above. This is because in the graph above, one needs to compare the investment performance he or she wants to know relative to the investment performance at the time of investment start.

As yet another problem, it is difficult to see from the graph in FIG. 1 how investment performance changes every month during a specific period, for example, during a year of 2021, and it is more challenging to quantitatively determine the monthly performance metrics of the current investment assets, compared to the price fluctuations or excluding the price fluctuations in the underlying asset in 2021.

The concept that can solve all of these problems at once is the estimated value based on a reference value.

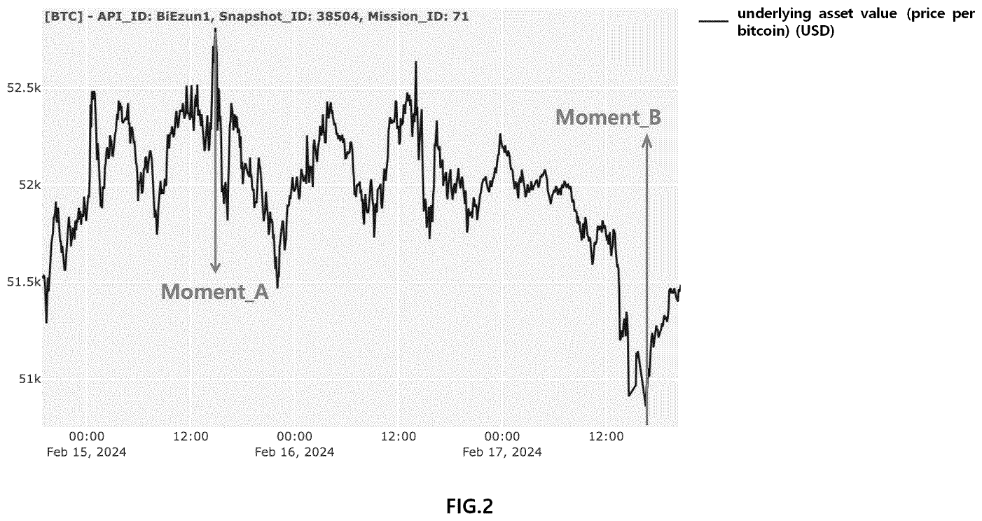

In order to describe the estimated value based on a reference value, which is the core concept of the present disclosure, the actual management results of an investment product including Bitcoin, will be explained with reference to FIGS. 2 to 6 as an example.

Prior to explanation, in this example, which corresponds to one embodiment, a “reference value” is set as the highest point of an “underlying asset value” that has occurred since the time of investment. In addition, an “estimated value based on a reference value” is calculated using an “evaluated value of assets held” when the current “underlying asset value” becomes the “reference value” according to the method described in the present disclosure.

First, the graphs shown in FIGS. 2 to 6 all indicate the same time period, and the graphs show changes that occurred between Feb. 15, 2024 and Feb. 17, 2024.

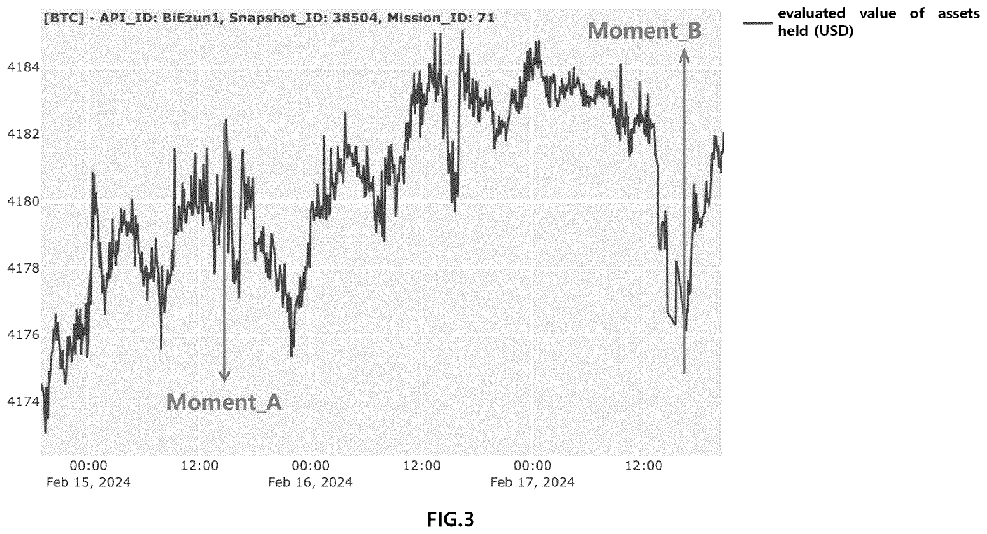

FIG. 2 is a simple graph showing the change in price per Bitcoin. The price started at the $51, 500 level and ended at a similar level, around $51,500. FIG. 2 is a graph showing the price of one Bitcoin at every moment, that is, an “underlying asset value” referred to in the present disclosure. In this example, two specific time zones are indicated to facilitate explanation. There is Moment_A, the moment when the “underlying asset value” is the highest in the relevant time period, and there is Moment_B, the moment when the “underlying asset value” is the lowest. Moment_A and Moment_B will be used to refer to the same time period in FIGS. 3 to 6 to aid understanding.

FIG. 3 shows an “evaluated value of assets held” over time. The “evaluated value of assets held” at the time of starting was around $4, 174, and the “evaluated value of assets held” at the end was $4,182. Comparing the graph in FIG. 3 with the graph in FIG. 2, overall, when the Bitcoin price rises, the “evaluated value of assets held” tends to rise, and when the Bitcoin price falls, the “evaluated value of assets held” also tends to fall. This is natural because some investment is in Bitcoin. Referring to FIG. 3, it can be confirmed that at Moment_A, where Bitcoin, as mentioned in the explanation of FIG. 2, is at its highest point in the corresponding time period, the “evaluated value of assets held” has also increased compared to the “evaluated value of assets held” at the start, and at Moment_B, where Bitcoin is at its lowest point in the corresponding time period, the “evaluated value of assets held” is lower than the previous valuation but is not the lowest amount in the entire time period. This shows that the graph in FIG. 3 does not exactly match FIG. 2, which is the “underlying asset value” graph, due to the investment activities or investment position of the product and the trend is slightly different. That is, this indicates that the “evaluated value of assets held” exhibits a marginal upward trend over time relative to the “underlying asset value” although when looking at the presented graphs in detail, the problem that it is difficult to accurately determine how well the investment is progressing still exists even in FIG. 3 or in the comparison of FIGS. 2 and 3 because of changes in the “underlying asset value” and other deviations. In other words, through a simple comparison between the “underlying asset value” shown in FIG. 2 and the “evaluated value of assets held” shown in FIG. 3, it is still difficult to accurately compare how excellent the investment performance is at each moment.

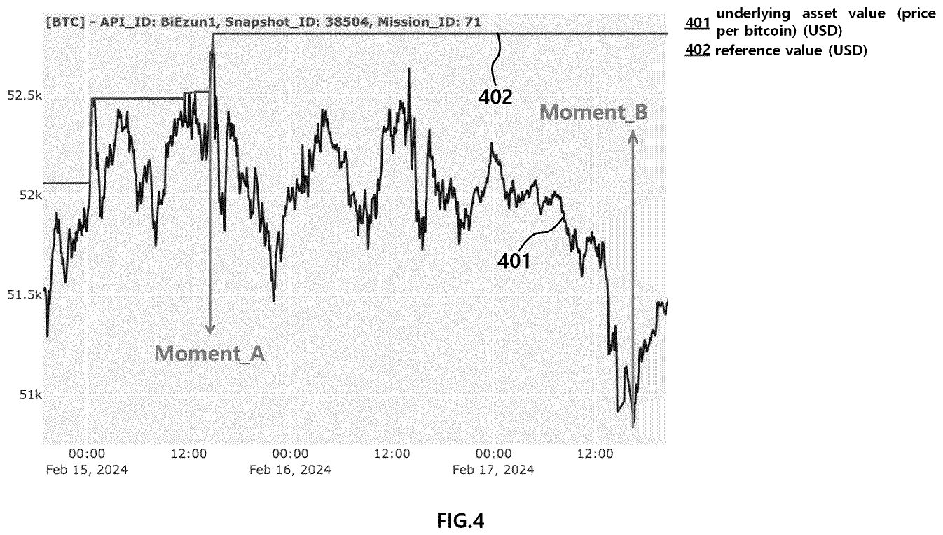

FIG. 4 is a graph showing a “reference value” along with the “underlying asset value” shown in FIG. 1. As mentioned earlier, the “reference value” was set as the highest point of the “underlying asset value” that occurred after the time of investment. The graph shows changes over time in the “reference value” (402) and the “underlying asset value” after the start of investment. At first, the “reference value” was around $52, 100, but as the “underlying asset value” (401) rose, the “reference value” was raised three times. The last increase in the “reference value” occurred at Moment_A, and the price at that time was $52,800, and the reference value remained the same until the end of the graph. Depending on the method of determining a “reference value”, the “reference value” remains the same even in situations where an “underlying asset value” falls to the lowest point, such as Moment_B.

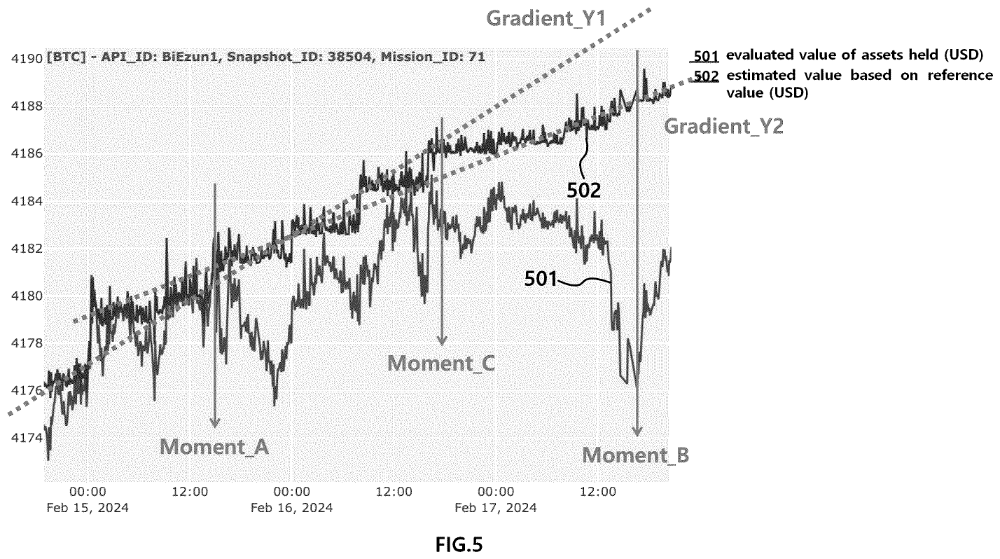

FIG. 5 shows an “estimated value based on a reference value” along with the “evaluated value of assets held” presented in FIG. 3. That is, FIG. 5 shows an “estimated value based on a reference value” (502), along with the “evaluated value of assets held” (501), calculated by estimating an “evaluated value of assets held” when the currently invested Bitcoin becomes a “reference value”.

As can be seen in the graph in FIG. 5, the “estimated value based on a reference value” (502) and the “evaluated value of assets held” (501) show different characteristics. That is, while the “evaluated value of assets held” (501) continues to fluctuate due to the influence of changes in the “underlying asset value” shown in FIG. 2, making it difficult to determine how the gains on investment assets actually occurred due to investment activities such as buying and selling, the estimated value based on a reference value” (502) of FIG. 5 shows results that are almost unaffected by changes in the “underlying asset value” of FIG. 2. In addition, since the “estimated value based on a reference value” (502) of FIG. 5 is shown based on the “reference value” of FIG. 4 that satisfies a certain condition, the increase and decrease in profits and losses on investment assets due to investment activities may be accurately checked on a moment-by-moment basis. An increase in the “estimated value based on a reference value” corresponds to a net gain attributable to this investment product, and the reason why this is possible is because the fluctuations in the “underlying asset value” are removed by comparing the valuations relative to a certain standard.

As can be seen in this example, by calculating and using an “estimated value based on a reference value” on the basis of a certain standard, that is, a “reference value” regardless of the temporary rise or fall in the price of Bitcoin, an “underlying asset value”, it is possible to eliminate or minimize the impact of the rise and fall of the price of Bitcoin, and thus gain and loss from investment activities in the meantime may be more accurately identified. That is, one can more readily discern the increase or decrease in profit or loss due to investment activities, and may determine whether the profit/loss occurrence rate over time continues at the same level or changes irregularly over time. If there were no investment activities, an “estimated value based on a reference value” would be the same regardless of the change in a “reference value”. This is because, although an “underlying asset value” may change at every moment, the current “evaluated value of assets held” is converted using a “reference value”, which corresponds to the same “underlying asset value”, and calculated as an “estimated value based on a reference value”, even in a situation where the “underlying asset value” changes, the “estimated value based on a reference value” will have the same value regardless of the change in the “underlying asset value”. If investment activities such as buying and selling took place in the meantime, and profits and losses occurred at that time, the profits and losses will be reflected and displayed in the “estimated value based on a reference value”. According to the description so far, the present disclosure is a method of eliminating changes in an “underlying asset value” as much as possible, so even if the profit is small, the difference may be easily confirmed through an “estimated value based on a reference value”.

A more detailed quantitative analysis is provided using the results illustrated in FIG. 5. The management results of this investment product show that the “estimated value based on a reference value” of this investment asset is steadily and consistently rising for all time periods, including Moment_A, when the “underlying asset value” was at its highest point, and Moment_B, when the “underlying asset value” was at its lowest point. This means that, unlike the characteristics shown in the graphs of the change in “underlying asset value” and the resulting change in “evaluated value of assets held” shown in FIGS. 2 and 3, the “estimated value based on a reference value” steadily increases, which effectively shows that profit is steadily increasing at every moment for the entire time currently shown according to the explanation so far. That is, even at the highest price level such as Moment_A and the lowest price level such as Moment_B, it is possible to more easily identify profits from investment activities because the impact of changes in the “underlying asset value” has been eliminated. By applying this methodology to other time intervals, it becomes possible to quantitatively evaluate how effectively and consistently the investment product performs relative to Bitcoin, the underlying asset, across varying periods. In conclusion, it can be seen from this example that the present disclosure makes it possible to easily and immediately determine the profits generated by the management of this investment product, regardless of changes in the “underlying asset value”. From the graph of “estimated value based on a reference value” (502) in FIG. 5 shown as an example, it can be seen that it is possible to determine the profit over time of this investment product while minimizing the impact of market fluctuations such as an “underlying asset value”.

In more detail, to explain a way to understand how investment performance changes over time in an example situation, information such as the slope of an “estimated value based on a reference value” may be used. The “estimated value based on a reference value” (502) in FIG. 5 continues to increase along the dotted line shown as Gradient Y1, and then the slope changes at Moment_C and increases along Gradient_Y2. Moment_C is not a specific point defined by a certain criterion, but rather an arbitrary point chosen to illustrate the change in slope. The fact that the slope of Gradient_Y1 is higher than the slope of Gradient_Y2 indicates that the investment performance has decreased after the point where the slope changes, compared to before. From this situation, it can be learned that an “estimated value based on a reference value” provides important information not only by the increase in the amount, but also by the growth rate, slope, or derivative value of this amount, which can be used as an important indicator to judge how the investment during the corresponding section compares to other time periods. The growth rate, slope, or derivative value of an “estimated value based on a reference value” may be calculated and used, and the relevant information may be added to a graph and displayed on a display device.

These characteristics are very important factors in evaluating financial products because in a situation where changes in internal investment areas and changes in the investment environment are affecting the performance of a financial product, even for the same financial product, a direct and easy monitoring tool may be provided to investors and consumers of financial products.

To explain further, the investment asset shown in FIG. 5 showed excellent characteristics such that the “estimated value based on a reference value” increases consistently at all moments, but it is obvious that there are many cases where this is not the case. For example, in the case of FIG. 1, it is difficult to estimate and calculate an “estimated value based on a reference value” because there is no detailed data, but if it is displayed, the “estimated value based on a reference value” will be the highest valuation around TimeZone_X, and will continue to decrease thereafter. This means that although the fund achieved excellent performance up to TimeZone_X, subsequent investment activities such as buying and selling indicate that wrong (inappropriate) investments were made in a way that reduced the investment performance previously achieved, and from an investor's perspective, it may be desirable to exit the investment at TimeZone_X.

There may be various ways to calculate an “estimated value based on a reference value”, but the key is that any formula can be used as long as it can infer an “evaluated value of assets held” when an “underlying asset value” currently invested becomes a “reference value”.

It is assumed that an investor invested 10 million won in financial product A when the KOPSI200 index reached 300. It is assumed that, in accordance with internal investment regulations, financial product A is a product that automatically buys 100 KODEX 200 (069500) ETF products for 30,000 won with 3 million won, buys 200 KODEX leveraged (122630) ETFs at 15,000 won with another 3 million won, and holds 4 million won in cash. For convenience of calculation, it is assumed that all transactions have no fees or other costs or profits, and the price of the KODEX 200 (069500) ETF is fixed at 1 time the rate of change of KOPSI200, and the price of the KODEX Leveraged (122630) ETF is fixed at 2 times the rate of change of KOPSI200.

For such a product, an “underlying asset value” may be the KOPSI200 index, and in this case, the starting value of the “underlying asset value” is 300. After the initial investment amount of 10 million won in financial product A, an “evaluated value of assets held” becomes equal to this initial investment amount. The “evaluated value of assets held” is calculated as 30,000 won*100 (KODEX 200 ETF valuation)+15,000 won*200 (KODEX leverage ETF valuation)+4,000,000 won (cash), and the total amount, that is, the “evaluated value of assets held” is 10,000,000 won. Now, as an example of a case where an “underlying asset value” changes, it is assumed that the “underlying asset value” increases by 10% to 330. This is a case where the “underlying asset value” at the time of investment was 300, and the “underlying asset value” has increased to 330 at the current time. In this case, KODEX 200 ETF rises by 10% and KODEX Leveraged ETF rises by 20%, resulting in 33,000 won and 18,000 won, respectively, and in this case, an “evaluated value of assets held” is calculated as 33,000 won*100 (KODEX 200 ETF valuation)+18,000 won*200 (KODEX leverage ETF valuation)+4,000,000 won (cash). Thus, the total “evaluated value of assets held” is 10,900,000 won. According to the explanation so far, as the “underlying asset value” has changed, the “evaluated value of assets held” has changed accordingly.

Now, a “reference value” and an “estimated value based on a reference value” will be calculated in this example. As previously described, a “reference value” may be set in a variety of ways, but in this example for simple explanation, it is assumed that a “reference value” is fixed at twice the initial price. In this case, the “reference value” may be set at 600, which is twice the KOPSI200 index of 300 at the time of investment start. In this case, since the “reference value” is not supposed to change over time, it will always be 600 regardless of the time since signing up for the investment product. Now, an “estimated value based on a reference value” at the moment of sign up will be calculated. The KOPSI200 index at the time of sign up was 300, and one needs to figure out what happens to an “evaluated value of assets held” when the “reference value” reaches 600. Accordingly, the “estimated value based on a reference value” is calculated as 30,000 won*600/300*100 (KODEX 200 ETF valuation)+15,000 won*2*600/300*200 (KODEX leveraged ETF valuation))+4,000,000 won (cash), and the result is 22,000,000 won. In the calculation formula, the ratio of “600/300” and “2*600/300” is the variability ratio at which the price of each asset changes according to the change in the “reference value”. In the case of KODEX leveraged ETF, since it was said to fluctuate by 2 times, this is reflected. In the case of cash, since there is no rate of change according to changes in the “reference value”, the variability ratio is 1 and is not indicated separately in the formula.

NOW, finally, through a calculation example, one can confirm that the “estimated value based on a reference value” does not change even in a situation where the previously calculated “underlying asset value” increases by 10% to 330. When the “underlying asset value” increases by 10%, the final “evaluated value of assets held” is 10,900,000 won, an increase of 900,000 won from the initial “evaluated value of assets held” of 10,000,000 won. In this situation, the “estimated value based on a reference value” is calculated as 33,000 won*600/330*100 (KODEX 200 ETF valuation)+18,000 won*2*600/360*200 (KODEX leveraged ETF valuation))+4,000,000 won (cash), and finally, the “estimated value based on a reference value” is calculated as 22,000,000 won. In the calculation formula, the ratio of “600/330” and “2*600/360” is the variability ratio at which the price of each asset changes according to the change in the “reference value” when the “underlying asset value” increases by 10%. In the case of KODEX leveraged ETF, since it was said to fluctuate by 2 times, this is reflected. In the case of cash, since there is no rate of change according to changes in the “reference value”, the variability ratio is 1 and is not indicated separately in the formula. In conclusion, it can be seen that although the “underlying asset value” increased by 10%, the “estimated value based on a reference value” did not change before and after the increase. The reason why the “estimated value based on a reference value” can be fixed is because the situation where the KOPSI200 index is 600, which was determined as the “reference value” condition, was consistently applied to the calculations.

So far, through examples for explanation, explained the principle that an “estimated value based on a reference value” does not change depending on the change in a “reference value”. If a difference occurs when the “estimated value based on a reference value” is calculated through the above process, the difference corresponds to the profit or loss that occurred due to the investment activities or investment position. In conclusion, the fact that investment performance, that is, profit and loss, may be confirmed more accurately while minimizing the impact of changes in a “reference value”, that is, changes in market conditions, described so far is the point that is continuously stressed in the present disclosure.

In the case of two financial time series data, such as the example KOSPI200 index and KODEX 200 ETF, or KOSPI200 index and KODEX 200 ETF, correlations in real financial data may change over time and may be linear or non-linear.

First, the correlation analysis method that can be used depending on the situation needs to be considered. Correlation analysis can be done in a variety of ways. When the linear correlation is large, Pearson's correlation coefficient may be used, and when the non-linear correlation is large, Spearman's rank correlation coefficient and Kendall's Tau may be used.

The variability ratio may be determined specifically through correlation analysis between basic financial data. For example, when analyzing the relationship between the KOSPI200 index and the KODEX 200 leverage based on the KOSPI200 index, the linear correlation between the two assets is confirmed through the Pearson correlation coefficient in the initial stage. If the correlation is strong (i.e., the Pearson correlation coefficient is close to +1), then a strong positive linear relationship exists between the two assets. This suggests that KODEX 200 leverage accurately reflects changes in the KOSPI200 index at a certain rate.

On the basis of this analysis, the variability ratio may be calculated specifically using regression analysis. In this process, the fluctuation rates of two financial assets are compared and analyzed to calculate, for example, to what multiple the KODEX 200 leverage reflects the fluctuation in the KOSPI200 index. Through this analysis, it is possible to calculate the variability ratio in asset valuation using two different financial time series data, such as KODEX 200 leveraged ETF according to changes in the KOSPI200 index. The variability ratio obtained through the process may be a value that changes over time or may be a fixed value.

If the process is generalized, an “evaluated value of assets held” and an “estimated value based on a reference value” may be derived using the following formula.

$$evaluated value of assets held {{\sum }^{N}}_{K - 1} {valuation}_{k} \qquad [ Equation 1 ]$$

$$\begin{matrix}estimated value value based on reference value \\ = {{\sum }^{N}}_{K - 1} {valuation}_{k} \times variability {\_ratio}_{k}\end{matrix} \qquad [ Equation 2 ]$$

In the formula, it is assumed that there are N assets, the current valuation of the kth asset is taken as valuationₖ, and the variability ratio calculated for the kth asset is expressed as variability_ratioₖ. At this time, the variability_ratioₖ represents the expected rate of change when the kth asset's value changes from its current value (calculated at the current “underlying asset value”) to its expected value at the “reference value”, and this ratio is calculated through correlation analysis between financial data as explained above, and the value is calculated through correlation analysis between financial data as described above. For elements that are not affected by changes in an “underlying asset value”, such as cash, the variability ratio may be set to 1. For other assets, the correlation with the “underlying asset value” may be analyzed in advance for each asset and the resulting figure may be used to set the variability ratio. Due to the nature of most financial products, each asset may have a different variability ratio, and the variability ratio may also change over time.

As previously described, the only constraint in the calculation formula for an “estimated value based on a reference value” is that when an “underlying asset value” becomes a “reference value”, an “evaluated value of assets held” matches the “estimated value based on a reference value”. Thus, any “estimated value based on a reference value” formula that conforms to this may be used, and the variability ratio, variability_ratioₖ, of each asset required to derive the “estimated value based on a reference value” may also be set according to the characteristics of each asset and used in calculations to comply with these principles.

In the case of the example presented above, although the “underlying asset value” was set to the KOPSI200 index, and the composition of investment products was explained simply based on three products: KODEX 200 (069500) ETF, KODEX Leveraged (122630) ETF, and cash, this is an example for understanding, and in actual investment products, the design may be much more complicated. In addition, in the previous example, it was assumed that the asset prices of KODEX 200 (069500) ETF and KODEX Leveraged (122630) ETF would be fixed and changed at 1 and 2 times the KOPSI200 index, but in reality, this is not exactly the case. That is, each of the KODEX 200 (069500) ETF and KODEX Leveraged (122630) ETF may be expected to change at 1 and 2 times the KOPSI200 index, and in the big picture, the product is operated so as to follow the index, but this is generally not the case at all times. Depending on the financial situation, there are times when index tracking is successful and there are times when this is not the case. Along with these situational factors, when the structure of a financial product is complex, it is sometimes difficult to derive a perfect “estimated value based on a reference value” mathematically. In this case, various approximate approaches may be taken, which means that a certain degree of error may be included. In fact, as can be seen in FIG. 5, when looking at the “estimated value based on a reference value” graph presented as an example of actual operation, one can see that it slopes upward in the form of a staircase, but when looking closely at smaller time units, there are small movements that appear sharp and somewhat regular, and these represent the errors. However, as shown in FIG. 5, if an appropriate approximation is made to derive an “estimated value based on a reference value”, it can provide sufficiently recognizable trends over a wide time interval, and the errors that occur in this case do not cause major problems in interpretation.

As such, an “estimated value based on a reference value” is an easy and convenient way to intuitively evaluate how well the current investment is compared to an underlying asset. An “estimated value based on a reference value” has endless applications. An “estimated value based on a reference value” may be applied to all existing investment assets, and the application may be expanded to all areas related to investment and investment product evaluation, including all financial companies and financial advisors that trade or broker those investment assets. When an “estimated value based on a reference value” is displayed together with the existing method or alone, it is possible to easily determine which asset has relatively better performance, and even for the same asset, one can easily see how investment performance changes over time.

In the current example case, although the method of determining a “reference value” was explained by setting it as the highest point of an “underlying asset value” that occurred after investment, as explained in the example so far, a “reference value” may be determined in a variety of different ways according to predetermined rules. For example, a “reference value” may be set as an “underlying asset value” at the time of starting investment, or may be set as an arbitrary value in the future or past. The point is that the standard is announced in advance and should be a value from which an “estimated value based on a reference value” may be derived according to this standard. An “underlying asset value” may be a fixed value or a value that may change over time. As previously described, depending on how a “reference value” is defined, an “estimated value based on a reference value” derived based on the “reference value” varies, and thus a “reference value” may be implemented by selecting an appropriate method depending on the situation.

Among the possible methods of determining a “reference value”, there is a special advantage when a “reference value” is set as the highest point of an “underlying asset value” after investment, which will be explained. When a “reference value” is set as the highest point of an “underlying asset value” after investment, a “reference value” is changed only under certain conditions, that is, when an “underlying asset value” becomes larger than the current “reference value”, but an “underlying asset value” changes in real time according to the market. In this case, a situation may arise where an “underlying asset value” approaches a “reference value” again. Such situation occurs when an “underlying asset value” approaches or exceeds the previous high point. In this case, that is, when an “underlying asset value” becomes the same as a “reference value”, an “evaluated value of assets held” becomes the same as an “estimated value based on a reference value”. This is because, as explained above, an “estimated value based on a reference value” was calculated to be an “evaluated value of assets held” when a “reference value” and an “underlying asset value” become the same. Therefore, in situations before and after an “underlying asset value” and a “reference value” become close, it is possible to check whether an “evaluated value of assets held” is normally close to an “estimated value based on a reference value”, and this process provides an opportunity to verify whether an “estimated value based on a reference value” presented so far has been properly derived. In other words, by checking how an “evaluated value of assets held” actually approaches an “estimated value based on a reference value” that has been presented each time a “reference value” reaches the previous high point or at a time before or after that, there is an additional advantage of having the opportunity to verify whether an “estimated value based on a reference value” has been properly calculated.

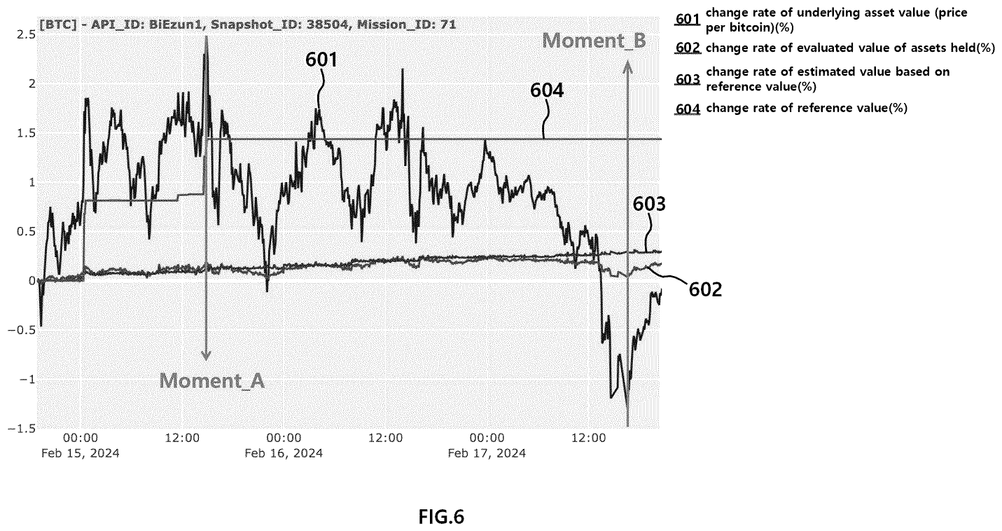

FIG. 6 shows the change rate as a percentage based on the starting point value for each of the “underlying asset value”, the “evaluated value of assets held”, the “reference value”, and the “estimated value based on a reference value” shown in FIGS. 2 to 5. According to the present disclosure, the history of an “estimated value based on a reference value” or the history of the change rate of an “estimated value based on a reference value” up to the time of evaluation may be displayed as a graph on the display device.

The results of this investment product will be summarized using the concepts explained so far. While the price per Bitcoin, the main underlying asset, that is, the rate of change (601) of the “underlying asset value” fluctuated from +2.5% to −1.5% during the corresponding time period, the rate of change (602) of the “evaluated value of assets held”, which reflects the current price of the product currently being invested shows a small change of about 0.2% and is rising. This means that exposure to Bitcoin is relatively small and investments are being made. In the graph in FIG. 6 showing the rate of change, it can be seen that the rate of change (602) of the “evaluated value of assets held” decreases slightly at Moment_B, the point at which the “underlying asset value” becomes minimum, as seen in FIG. 3. The important point here is the rate of change (603) in the “estimated value based on a reference value”. It can be seen that there is a constant increase in all sections, and as a result, investment returns are consistently generated in all sections. This can be seen by confirming a certain level of profitability from the “estimated value based on a reference value” regardless of Moment_A, where the “underlying asset value” is at the high point, and Moment_B, where the “underlying asset value” is at the low point. The reason why this is possible is because the current investment performance is derived from the “reference value” through the “estimated value based on a reference value”, regardless of changes in the “underlying asset value”, and this investment product can be evaluated as a fairly excellent investment product because the “estimated value based on a reference value” steadily increases regardless of whether the “underlying asset value” increases or decreases.

The current explanation exemplifies a very short time period, equivalent to a few days, which is relatively short from a general investment perspective, but this is an intentional setting to show that evaluation is possible even in short time intervals where accurate evaluation or comparison of profits is difficult. If this method is applied to a longer period such as a month or a year, the change in an “estimated value based on a reference value” is more clearly revealed, and the investment performance may be seen through the change in an “estimated value based on a reference value” in the same way. In particular, even within the same product, it is possible to directly gain insights into how investment performance changes over time through the rate of change in an “estimated value based on a reference value” depending on a specific time period. In the end, even in a specific financial product, investment performance may be directly compared between times when investments are doing well and when investments are not doing well over time. In the present disclosure, an investment asset set may be an investment product in which the types and quantities of investment assets held may change over time, and for such investment product, a method of investment evaluation using an “estimated value based on a reference value” of the present disclosure may be used to evaluate investment performance.

The explanation so far has used the value of an “estimated value based on a reference value” itself and the change rate of an “estimated value based on a reference value” as examples, but in addition to the above examples, through various analyses of various statistics on an “estimated value based on a reference value”, for example, variance and standard deviation, it is possible to make a relative comparison with the current valuation of other investment assets, thereby enabling more efficient comparison of investment products. Therefore, it will be understood that any method using an “estimated value based on a reference value” is within the scope of the present disclosure. Another very important feature is that although current investment assets are diverse, including stocks, bonds, crypto, etc., they may all be evaluated using the same method discussed in the present disclosure. In conclusion, the present disclosure may be applied in the same way to all investment assets. When each investment asset is evaluated using the method of the present disclosure, if one can find an investment product in which the rate of change in an “estimated value based on a reference value” is kept constant as high as possible in the positive direction and the deviation in the slope change rate over time is as small as possible, that product can be said to be the best product. However, investments cannot be evaluated only by returns, as there are other factors as well, and thus is obvious that if an “estimated value based on a reference value” or any method derived from the figure of an “estimated value based on a reference value” is used while including these factors, that is also within the scope of the present disclosure.

Although in the case of complex investment products, it may be difficult to derive an “estimated value based on a reference value” from a “reference value” determined by predetermined rules, an “estimated value based on a reference value” may be implemented in various ways because the “estimated value based on a reference value” only needs to match an “evaluated value of assets held” when the current “underlying asset value” becomes a “reference value”.

The method of the present disclosure has a special feature compared to existing evaluation methods. The special feature is that an “evaluated value of assets held” when an “underlying asset value” called a “reference value” becomes a specific price is set as an “estimated value based on a reference value”, and this is used. This is a more objective and convenient technique for evaluating the investment results of specific financial products by eliminating as much as possible the fluctuations in an “underlying asset value” with the converted valuation, an “estimated value based on a reference value”.

To help with further understanding, the method of the present disclosure will be compared with a relative strength index (RS) technique, which is one of the commonly used methods. The RS is an indicator that measures how strong a specific asset is compared to other assets in the financial market. The RS compares the rate of price change of two assets and indicates the relative performance thereof. For example, when comparing Apple stock and the Dow, if Apple stock is up 10% and the Dow is up 5% over a certain period, Apple's RS is 2. This means that Apple stock performed twice as strongly as the Dow over that period, and investors use this information to decide whether to invest in stocks that outperform the market average.

On the other hand, the present disclosure proposes a new method of evaluating the value of assets by introducing a “reference value”. This approach eliminates the volatility of an underlying asset when determining the value of a specific financial product, thereby enabling a more stable and objective valuation. The present disclosure helps investors identify the true value of assets while being less affected by market volatility by allowing the value of assets to be evaluated at a specific price regardless of changes in an underlying asset value.

When compared comprehensively, the RS and the present disclosure evaluate the value of assets from different perspectives. While the RS provides a method of measuring relative performance within the market, the present disclosure focuses on evaluating performance in a way that excludes the volatility of an underlying asset. While the RS is useful when understanding market dynamics and seeking investment opportunities based on relative performance, the present disclosure demonstrates the strengths thereof when evaluating the intrinsic value of assets or investment results for investment assets even in markets with high volatility.

Although the present disclosure has been mainly described from the perspective of individual investors, that is, the public, the present disclosure may be similarly explained and utilized from the perspective of professional investors or investment institutions. Thus, the present disclosure should not be limited to an invention for public investors, and it is obvious that the present disclosure can be used for various investment activities or activities that show investment results.

The present disclosure includes the technical content described above, and at the same time includes all of the following examples: the act of a computer calculating an “estimated value based on a reference value” or an equivalent value thereof; the act of calculating an “estimated value based on a reference value” or an equivalent value thereof and showing or representing the resulting figure in a more understandable manner through graphs, tables, strings, or pictures; the act of helping or supporting better investment decisions by presenting an “estimated based on a reference value” or equivalent information to investors or investment institutions; and the act of attracting more investors or selling or inducing to buy investment products by presenting an “estimated value based on a reference value” or equivalent information alone or together with other information.

Although the embodiment was described using the price of Bitcoin, one of the crypto assets, as an “underlying asset value” to explain the present disclosure, similar application is possible to various financial products such as stocks, ETFs, and funds, which are traditional assets.

Although specific words were used in the above terms, it will be understood that the present disclosure can be described using other words, and as long as it meets the intended purpose, any word used should be included in the scope of the present disclosure regardless of whether a specific word is used.

What is claimed is:

1. A method, executed by a computer, of investment evaluation using an estimated value based on a reference value, the method comprising:
determining, according to a predetermined rule, a reference value selected from either historical values or future reference values of an underlying asset value, the underlying asset value corresponding to a price of an underlying asset chosen as a representative investment asset or a related benchmark index from one or more investment assets included in an investment asset set; and
converting, based on a variability ratio calculated under an assumption that the underlying asset value at an evaluation time changes to the determined reference value, a valuation of the investment asset set, and using the resulting converted valuation as an estimated value based on a reference value.

2. The method of claim 1, wherein the predetermined rule comprises selecting, as the reference value, a highest price recorded among the historical values of the underlying asset value from a start of an investment up to just before the evaluation time.

3. The method of claim 2, wherein when the underlying asset value is at the highest price at the evaluation time, an evaluated value of assets held, which is a valuation of the one or more investment assets included in the investment asset set at the time of evaluation, equals to the estimated value based on a reference value.

4. The method of claim 1, wherein the investment asset set is an investment product whose composition of asset types and quantities may vary over time, and is used to evaluate an investment performance of the investment product.

5. The method of claim 1, further comprising:
calculating and utilizing one or more metrics of the estimated value based on a reference value, the metrics including at least one of a growth rate, a slope, or a derivative value.

6. The method of claim 1, further comprising:
displaying, in graph form, a historical record of the estimated value based on a reference value up to the evaluation time, or a historical record of change rates of the estimated value based on a reference value.

7. The method of claim 1, if the investment asset set includes Bitcoin, the underlying asset is Bitcoin.

8. The method of claim 1, wherein the variability ratio is a unique value predicting a rate of change in a value of each investment asset when the underlying asset value reaches the determined reference value, and is derived via time series analysis based on historical price change data of the underlying asset and each investment asset.

9. The method of claim 1, further comprising:
performing statistical processing on one or more of a mean, variance, and standard deviation derived from historical data or increase/decrease records of the estimated value based on a reference value up to the evaluation time, and displaying the processed results in one or more formats selected from a graph, a table, or textual form.
